(19) United States
(12) Patent Application Publication
(10) Pub. No.: US 2026/0081807 A1
(43) Pub. Date: Mar. 19, 2026

(54) CONTROL UNIT FOR TRANSLATING BETWEEN DIFFERENT BUS INTERFACES

(71) Applicant: Infineon Technologies AG, Neubiberg (DE)

(72) Inventors: Anjana Ramamoorthy, München (DE); Viola Rieger, München (DE)

(21) Appl. No.: 18/888,532

(22) Filed: Sep. 18, 2024

(51) Int. Cl. H04L 12/40; B60R 16/023; H04L 45/02

(52) U.S. Cl. CPC H04L 12/40; B60R 16/0231; H04L 45/02; H04L 2012/40215; H04L 2012/40234; H04L 2012/40273

(57) ABSTRACT

Some embodiments relate to a control unit including a Controller Area Network (CAN) interface including a plurality of serial communication ports and an Ethernet interface. A first plurality of CAN-to-Stream-identifier (ID) logic circuits are coupled to the plurality of serial communication ports, respectively. A routing table is coupled to the first plurality of CAN-to-Stream-ID logic circuits. The routing table stores a first plurality of CAN IDs and a first plurality of Stream IDs, respectively. A Stream-ID-frame-to-Ethernet-frame-generation logic has a plurality of inputs coupled to respective outputs of the first plurality of CAN-to-Stream-ID logic circuits, respectively, and has respective outputs coupled to the Ethernet interface. The first plurality of CAN-to-Stream-ID logic circuits are instantiated in a first plurality of hardware circuits, respectively.

### FIELD

The present disclosure relates to electronic control units that interface to multiple bus standards.

### BACKGROUND

Compared to older vehicles, modern vehicles have an ever-growing number of sensors and control units. These sensors and control units are connected to one another by wireline busses. For example, modern automobiles may have between fifty and one-hundred control units for various subsystems. As automobiles utilize more data, finding effective ways to transport data between the sensors and control units is becoming more important.

### BRIEF DESCRIPTION OF THE DRAWINGS

FIG. 1 illustrates an example computer-controlled system in the form of a vehicle in accordance with some embodiments of the disclosure.

FIG. 2 illustrates an example embodiment of a control unit consistent with the system of FIG. 1.

FIG. 3A illustrates another example of a control unit in accordance with some embodiments of the disclosure.

FIG. 3B illustrates another example of a control unit in accordance with some embodiments of the disclosure.

FIG. 4 illustrates an example of a control unit that can translate controller area network (CAN) frames to Stream ID frames and to Ethernet IEEE 1722 frames (and vice versa).

FIG. 5 illustrates another example of a control unit in accordance with some embodiments of the disclosure.

FIG. 6 illustrates another example of a control unit in accordance with some embodiments of the disclosure.

FIG. 7 is a flowchart of an example process, in accordance with some embodiments of the disclosure, for performance by, for example, a control unit of FIGS. 1-6 that maps incoming CAN/LIN/other frames to outgoing Ethernet frames.

FIG. 8 is a flowchart of an example process, in accordance with some embodiments of the disclosure, for performance by, for example, a control unit of FIGS. 1-6 that maps incoming Ethernet frames to outgoing CAN/LIN/other frames.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware.

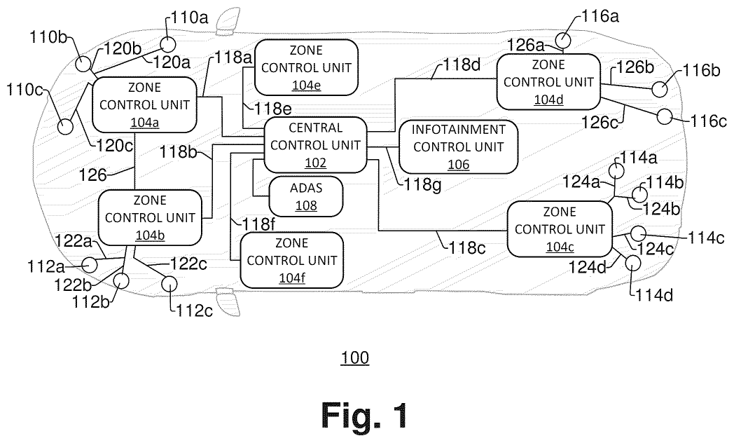

FIG. 1 shows an example vehicle 100 that includes a central control unit 102, a number of zone control units 104a-104f, an infotainment control unit 106, and an Advanced Driver Assistance System control unit (ADAS) 108. Any of these components 102-108 as well as sensors and/or other components may be referred to as a “control unit” as used herein. Sensors and/or other controllers (e.g., lighting control, sound control, and/or actuators) can be present in the vehicle 100 for doors, windows, drive train, brakes, steering, seats, heating and cooling, sound system, and so on. These control units are coupled together via various wireline busses. For example, a first group of sensors and/or controllers 110a-110c can be coupled to a first zone control unit 104a via busses 120a-120c, respectively; a second group of sensors and/or controllers 112a-112c can be coupled to a second zone control unit 104b via busses 122a-122c, respectively; a third group of sensors and/or controllers 114a-114d can be coupled to a third zone control unit 104c via busses 124a-124d, respectively; and a fourth group of sensors and/or controllers 116a-116c can be coupled to a fourth zone control unit 104d via busses 126a-126c, respectively. Other busses (e.g., 118a, 118b, 118c, 118d, 118e, 118f, and 118g) can also couple various control units to one another. Typically, the central control unit 102 and/or engine control unit are the largest control units that use the largest bandwidths, with other sensors and/or controllers often using smaller bandwidths (but alternatively the sensors and/or controllers can use greater bandwidths). Some of these control units can form independent subsystems (e.g., communication is limited to only one “link” between two directly adjacent control units), while other control units can be linked to one another through a chain of multiple control units.

One network protocol for wireline busses in vehicles is Controller Area Network (CAN). CAN is a two-wire bus standard designed to enable efficient communication. Thus, CAN nodes are connected to each other through a pair of twisted copper wires having a 120Ω (nominal) characteristic impedance. CAN is a broadcast-based, message-oriented protocol that ensures data integrity and prioritization through a process called arbitration, allowing the highest priority device to continue transmitting if multiple devices attempt to send data simultaneously, while others back off. Its reliability is enhanced by differential signaling, which mitigates electrical noise. Common versions of the CAN protocol include CAN 2.0, CAN FD, and CAN XL which vary in their data rate capabilities and maximum data payload sizes. In addition to automobiles, CAN is also used in electronic bikes (ebikes), golf carts, and other control systems, such as industrial control systems and others.

Local Interconnect Network (LIN) is another network protocol used for wireline busses extending between components in modern vehicles. LIN is a low-cost single-wire, serial protocol that supports communications up to 19.2 Kbit/s with a maximum bus length of 40 meters (131.2 ft.).

In FIG. 1, some of the control units may communicate with neighboring control units via CAN and/or LIN, among other network protocols. For example, each of the first group of sensors and/or controllers 110a-110c can be coupled to the first zone control unit 104a using one or more respective pairs of twisted copper wires that make up busses 120a-120c, respectively, and can communicate using the CAN protocol. In contrast, each of the second group of sensors and/or controllers 112a-112c can be coupled to the second zone control unit 104b using one or more respective single wires that make up busses 122a-122c, respectively, and can communicate using the LIN protocol. Some of the third group of sensors and/or controllers (e.g., 114a and 114b) can be coupled to the third zone control unit 104c using respective pairs of twisted copper wires (e.g., 124a and 124b) and can communicate using the CAN protocol, while others (e.g., 114c) of the third group of sensors and/or controllers can be coupled to the third zone control unit 104c using respective single wires (e.g., 124c) and can communicate using the LIN protocol, and so on.

CAN/LIN frames have a short frame length of 8-64 bytes, and for certain data rates this results in a high frame rate and this directly impacts processor/cpu loads. In other words, because the CAN/LIN frames are significantly shorter then Ethernet frames, the processor/cpu needs to be much faster to process CAN/LIN frames in order to keep up with the data rates. As such, CAN and/or LIN are becoming a bottleneck in vehicular communication. Therefore, vehicles are moving to Ethernet cables, which provide data speeds that are significantly faster than CAN and/or LIN. Under one approach, Ethernet cables are used exclusively throughout the entire vehicle for a unified, modern approach. However, legacy sensors/components offer still offer good value in many instances, and may communicate using CAN and/or LIN. Thus, there is a need for efficient techniques to make use of CAN/LIN and Ethernet in vehicles.

Accordingly, FIG. 1's vehicle provides a mix of CAN and/or LIN busses and as well as higher speed data busses, such as Ethernet busses. In FIG. 1's example, busses 118a-118g that couple the Central control unit 102 to various zone control units 104a-104f can be realized as Ethernet cables, and may also couple zone control units to one another (see 126), and/or may couple a zone control unit to one or more sensors and/or controllers (see 124d). Thus, when existing data speeds are sufficient, CAN/LIN busses are used to save re-design for legacy peripherals; but when higher speed data communication is required, Ethernet busses are used. This approach strikes a good balance between limiting unnecessary costs and providing good performance.

Because multiple communication protocols are used in the vehicle 100, the various control units can act as “bridges” between one node that communicates with a first protocol (e.g., CAN or LIN) and another node that communicates with a second, different protocol (e.g., Ethernet). For example, in the example described in FIG. 1, the zone control unit 104a communicates with controllers and/or sensors 110a-110c using CAN, and communicates with the central control unit 102 and/or zone control unit 104b using Ethernet. Therefore, when the zone control unit 104a relays CAN frames from controllers and/or sensors 110a-110c to central control unit 102 and/or zone control unit 104b, the zone control unit 104a has to “translate” incoming CAN frames from 110a-110c to outgoing Ethernet frames for 102 or 104b (and/or vice versa). Equivalently, other nodes translate incoming LIN frames to outgoing Ethernet frames (and/or vice versa). In some other approaches, this translation from CAN/LIN to Ethernet occurs solely in software running on a microprocessor within the zone control unit 104a. As appreciated in some aspects of the present disclosure, a single CPU in a control unit is often not sufficient to process frames quickly enough to comply with data throughput requirements. For example, some single CPU approaches where software is used to implement Ethernet IEEE1722 have a latency of 15.1 microseconds (per CAN frame data of 64 bytes). Assuming the CPU operates at a clock cycle of 500 MHz, it can take 7550 clock cycles to process each frame, and the CPU becomes 100% utilized at 66,000 frames per second, and 70% utilized at 46,000 frame per second. Therefore, a single CPU core is insufficient for control units that translate between CAN or LIN frames and 1722 Ethernet frames in future vehicles. Consequently, some aspects of the present disclosure make use of local routing engine hardware and CAN/LIN to Ethernet frame generation channels arranged within the various control units to improve data processing in the vehicle. This local routing engine hardware and CAN/LIN to Ethernet frame generation channels translate between CAN or LIN frames and 1722 Ethernet frames. The local routing engine hardware and CAN/LIN to Ethernet frame generation channels could alternatively translate other protocols, such as FLEXRAY or I2C or even wireless, to Ethernet and/or other higher speed protocols, for example as per the IEEE 1722 standard.

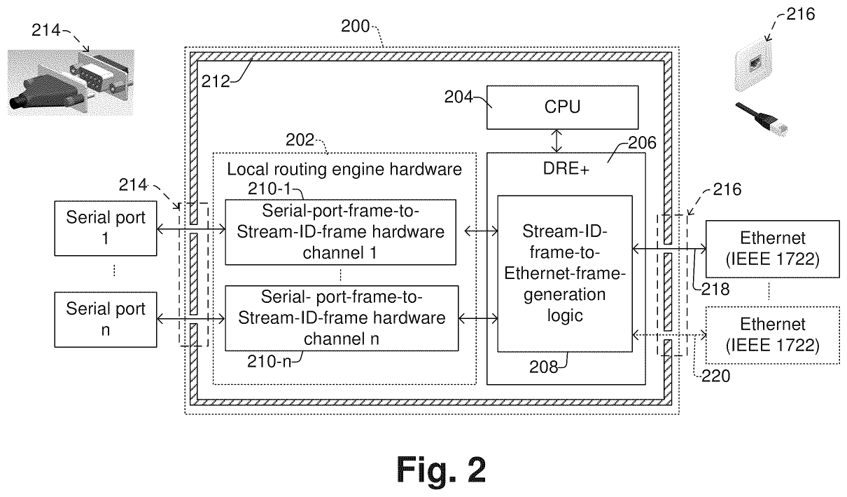

FIG. 2 shows a control unit 200 that includes local routing engine hardware 202 in accordance with some aspects of the present disclosure. In addition to the local routing engine hardware 202, the control unit 200 includes a central processing unit (CPU) 204, and a Data Routing Engine (e.g., DRE+) 206, which typically is a separate hardware circuit from the CPU 204. The control unit 200 (which can manifest as any of the control units, controllers, and/or sensors of FIG. 1) includes a housing 212, such as a plastic and/or metal case, that encases the local routing engine hardware 202, CPU 204, and DRE+ 206. The housing 212 includes openings for n serial communication ports 214, wherein n can be any positive integer number (e.g., n=1, 2, 3, . . . ). The serial communication ports 214 can, for example, be bi-directional transmission and reception ports or uni-directional transmission or reception ports. In some examples, the serial communication ports 214 can manifest as separate DE-9 connectors that have 9 pins for the male connectors and/or 9 receptacles for female connectors, but other standard connectors or even custom connectors can also be used. The housing 212 also includes openings for one or more bi-directional Ethernet ports 216.

The local routing engine hardware 202 includes n serial-port-frame-to-stream-ID-frame hardware channels 210-1 through 210-n, respectively. Each serial-port-frame-to-stream-ID-frame hardware channel has hardware that converts frame(s) or message(s) received on a given serial port to a Stream ID frame(s). Thus, the serial-port-frame-to-stream-ID-frame hardware channels 210-1 through 210-n can take disparate frames on the various serial ports (where the serial port frames on the respective serial ports can follow the same or different network protocol frame/message formats), and convert those disparate frames to a single Stream ID frame format. Within the DRE+ 206, a Stream-ID-frame-to-Ethernet-frame-generation logic 208 is instantiated as a hardware circuit. Upon receiving the various Stream ID frames from the channels 210-1 through 210-n, the Stream-ID-frame-to-Ethernet-frame-generation logic 208 then translates the Stream ID frames into Ethernet frames having the same Stream ID frame format as one another. The Stream-ID-frame-to-Ethernet-frame-generation logic 208 then transmits the Ethernet frames over the Ethernet port 216. In some examples, 208 can be implemented partially in software or firmware. The control unit 200 can also receive incoming Ethernet frames on the Ethernet ports 216, internally process those Ethernet frames, and then output out-going serial port frames to the serial communication ports 214 in response to the Ethernet frames. In some cases, incoming frames of multiple serial ports on 214 are transmitted as Ethernet packets on a single Ethernet port (e.g., see line 218 leading to upper Ethernet port). In other examples, however, incoming frames of multiple serial ports of 214 are transmitted as Ethernet packets on respective separate Ethernet ports (see line 218 and optional line 220 transmitting Ethernet packets via upper Ethernet port and optional lower Ethernet port, respectively).

In this way, the control unit 200 can provide interoperability between legacy serial port devices (which make use of serial communication ports 214) and modern high speed devices (which make use of Ethernet ports 216). In particular, the local routing engine hardware 202 accelerates processing/translation from serial port frames (e.g., CAN and/or LIN) to Ethernet frames, to help ensure that high data rates are achievable for system developers.

In some examples, the control unit 200 is included in a vehicle (e.g., vehicle 100 of FIG. 1), but can also be included in industrial systems or other systems. In some examples, the control unit 200 is a single standalone chip and 202, 204, 206, 208, and 210 are on a single die, but in other examples components 202, 204, 206, 208, and 210 are on multiple dies stacked over one another or arranged within a single integrated circuit package in the form of a so-called 3-dimensional IC. In still other examples, 202, 204, 206, 208, and 210 may be formed on multiple packaged chips and/or discrete components on a printed circuit board arranged within housing 212. A die may include a semiconductor substrate, such as a monocrystalline silicon substrate or a silicon on insulator substrate, but can also and/or alternatively include other semiconductor materials, such as gallium arsenide (GaAs), indium gallium arsenide (InGaAs), and germanium (Ge), among others. Further, the chip(s) can include transistors arranged to specifically carry out the functions of the control unit 200; and/or can be programmed with software or firmware instructions to carry out functions of the control unit 200.

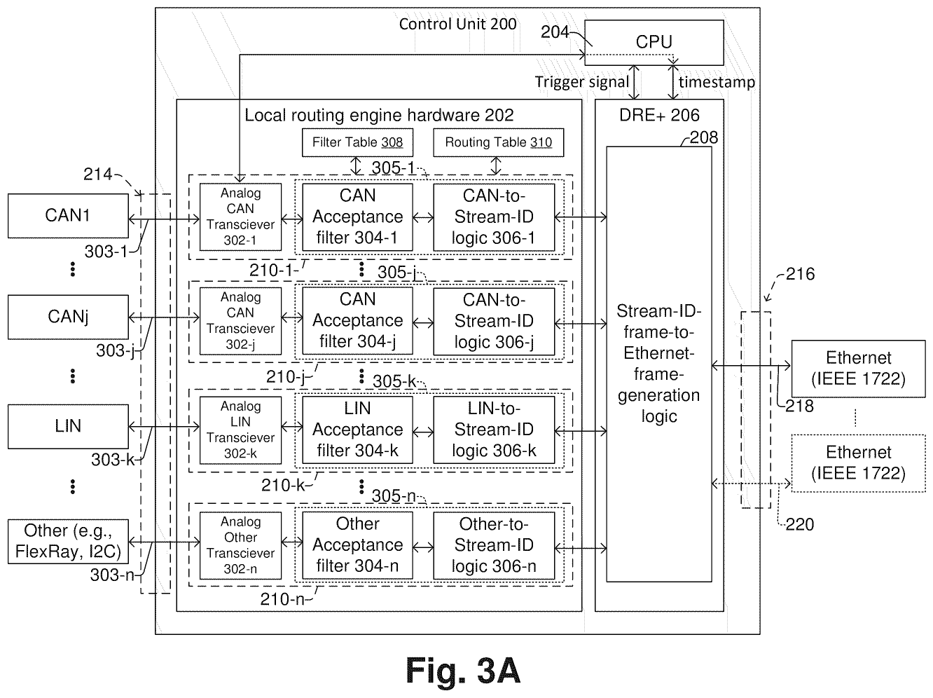

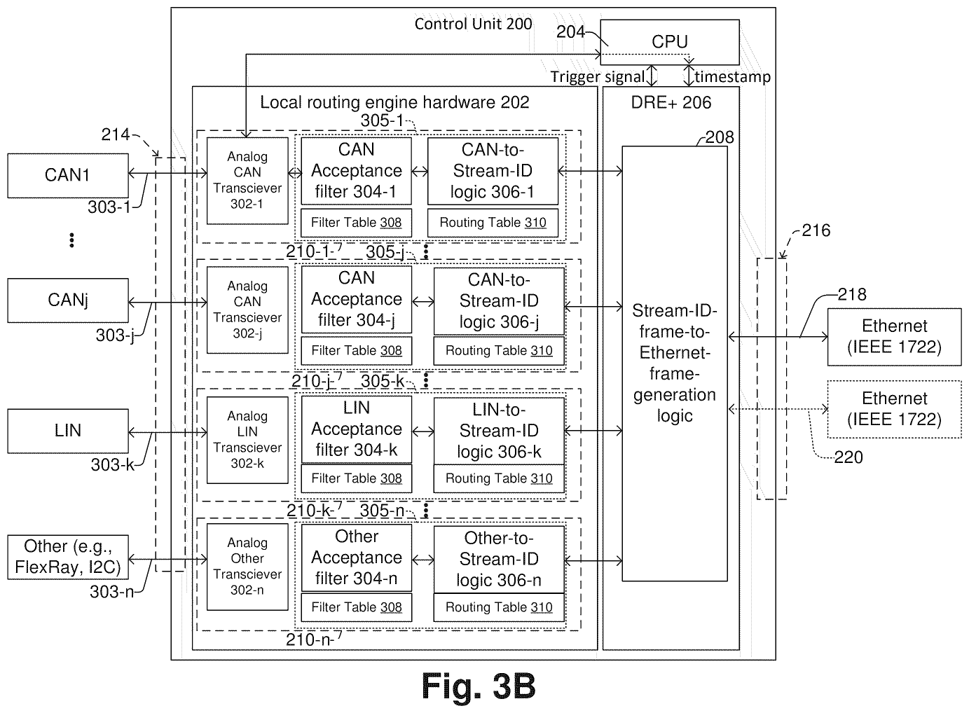

FIG. 3A shows another example of a control unit 200 that includes local routing engine hardware 202 in accordance with some aspects of the present disclosure. In this example, control unit includes n serial communication port(s) 303-1 through 303-n, respectively, on serial interface 214. The local routing engine hardware 202 includes channels 210-1 through 210-n coupled to the serial ports 306-1 through 306-n, respectively. The channels include analog transceivers 302-1 through 302-n, respectively, and n digital channels 305-1 through 305-n, respectively. A filter table 308 and a routing table 310 are also present. Often, the serial ports, analog transceivers, and digital channels correspond to one another in one-to-one fashion, but in other embodiments, multiplexers can be included so that some of these elements are shared between one or more channels/etc.

In the illustrated example, the serial ports of interface 214 are subdivided to include a first integer number, j, of CAN ports (e.g., 306-1, . . . , 306-j), a second integer number, k, of LIN ports (e.g., 306-k), and a third integer number, I, of other serial ports, such as FlexRay or I2C (e.g., 306-n), wherein j, k, and I can each be any positive integer or can be zero. Further, any of j, k, and I can be equal to one another or different.

Each digital channel 305 includes a filter that corresponds to the type of port for the corresponding serial communication port (e.g., 306-1, 306n respectively). For example, CAN acceptance filter(s) (e.g., 304-1 through 304-j) are coupled to the CAN ports, LIN acceptance filter(s) (e.g., 304-k) are coupled to the LIN port(s), and other acceptance filter(s) (e.g., 304-n) are coupled to the other port(s). The CAN acceptance filter(s) are often separate hardware circuits that correspond to the CAN ports in a one-to-one manner, and similarly LIN and/or other acceptance filter(s) 304 are often separate hardware circuits that correspond to the LIN and/or other ports in a one-to-one manner.

CAN to Stream ID logic hardware circuits (e.g., 306-1 to 306-j) are coupled between each CAN acceptance filter (e.g., 304-1 and 304-j) and Stream-ID-frame-to-Ethernet-frame-generation logic 208, and LIN-to-Stream-ID logic hardware circuits (e.g., 306-k) are coupled between each LIN acceptance filter (e.g., 304-k) and Stream-ID-frame-to-Ethernet-frame-generation logic 208. For each different network protocol supported, the serial-port-to-stream-ID logic hardware circuits have specific logic to extract the stream ID from that particular protocol/message format.

In various examples, the CAN channels 210-1 through 210-j can be substantially identical to one another in that they can have different addresses/channel numbers, but the same circuitry otherwise. Similarly, the LIN channels 210-k can be substantially identical to one another in that they can have different addresses/channel numbers, but same circuitry otherwise; and the LIN channels differ from the CAN channels in that one operates using LIN while the other operates using CAN. The same is true of the other channels 210-n.

For example, if the first communication port 303-1 is structured to communicate via CAN, then CAN acceptance filter 304-1 identifies whether signals/frames on the first serial communication port (CAN1) 303-1 are valid CAN signals. Further, the CAN acceptance filter 304-1 determines whether a CAN ID in each incoming CAN frame specifies that the incoming CAN frame is intended for a device that is logically linked to the control unit 200. The CAN acceptance filter 304-1 only passes the incoming CAN frame along to the CAN-to-Stream-ID logic circuit 306-1 and Stream-ID-frame-to-Ethernet-frame-generation logic 208 when the CAN acceptance filter 304-1 determines that the CAN ID of the incoming CAN frame specifies a device that is logically linked to the control unit 200. Otherwise, when the CAN ID of the incoming CAN frame does not match with a device that is logically linked to control unit 200, then the CAN acceptance filter 304-1 disregards the incoming CAN frame and does not pass it to the CAN routing logic 312. Thus, the CAN acceptance filter 304-1 can act as a whitelisting circuit in some regards. The LIN acceptance filters 304-k and other acceptance filters 304-n operate in an analogous manner, albeit using different network protocol frame/message formats. For incoming CAN frames, the CAN ID of the CAN frame is linked to a CAN serial port, and the CAN Acceptance filter accepts only valid CAN IDs into the channel. So if the CAN ID is a valid CAN ID linked to the control unit 200 (and thus listed in the Filter table 308), the CAN frame is forwarded to the CAN-to-Stream-ID logic 306-1 but otherwise the CAN frame is ignored and not passed to the CAN-to-Stream-ID logic 306-1. The CAN-to-Stream-ID logic 306-1 then maps the CAN IDs to 1722 Stream IDs (this is a specific bit-field in 1722 standard) using CAN IDs and Stream IDS stored in the routing table 310, which can be implemented as a lookup table. The CAN-to-Stream-ID logic circuit 306-1, then forwards the Stream IDs, along with the corresponding payload data from the CAN frames to the Stream-ID-frame-to-Ethernet-frame-generation logic 208. The Stream-ID-frame-to-Ethernet-frame-generation logic 208 then maps the Stream IDs to Ethernet Ports and MAC Addresses. The Stream-ID-frame-to-Ethernet-frame-generation logic 208 also builds an Ethernet frame having the same payload data and MAC destination address that were present in the incoming CAN frame, and specifies a MAC address of the control unit 200 as the MAC source address in this Ethernet frame. The MAC address is a static configuration per control unit in a specific scenario during runtime but the update of this bit-field can be done for every outgoing Ethernet frame. The configuration can be done by the manufacturer depending on his network/routing scenario in the vehicle, and the MAC addresses can be stored in another table on a higher level of abstraction programmed by the manufacturer.

The CPU 204 of the control unit 200 includes a clock signal received via a clock tree that is distributed over CPUs of the system (e.g., over the vehicle). Through the clock tree, the CPU 204 has a clock that is synchronized with other control units in the system. The clock tree can cascade a clock signal, one level at a time, between pairs of directly connected control units, until the local clocks of all of the control units are synchronized. Pairs of directly connected control units have consistent delay times between them and so can synchronize their respective local clocks fairly precisely (e.g., within a few nanoseconds). The cascading synchronization of clocks may be performed in accordance with a precision time protocol (PTP) such as, for example, defined in the IEEE 1588 standard.

The Ethernet ports 216 are configured to send and receive time-sensitive Ethernet frames, which comprises encapsulating payloads for transmission with a corresponding Ethernet header and decapsulating received payloads for processing by the appropriate module of the control unit 200. Thus, when incoming CAN frames arrive and are accepted, the CPU 204 is notified of the incoming CAN frame and generates a timestamp based on its local clock, which is synchronized with other clocks of the system. The timestamp is then encapsulated in the outgoing Ethernet frame, along with the MAC source and destination address, and payload data.

The list of CAN IDs, Stream IDs, and corresponding source and destination MAC addresses in the routing table 310 can be hard-coded into the routing table 310 (e.g., by bits stored in read-only memory (ROM) programmed during manufacture), or can be programmed into the routing table 310 by blowing fuses, programming flash or other volatile or non-volatile memory, or other suitable programming techniques. The list of CAN IDs, Stream IDs, and MAC source and destination addresses can be programmed during the manufacturing, testing, or initialization of the control unit (e.g., at an original equipment manufacturer (OEM) or other suitable location), and/or can be programmed or read at boot up, another regular time interval, or based on an interrupt, timer, or sensor value triggering such an event.

Thus, because local routing engine hardware 202 in combination with the DRE+ 206 helps provide interoperability between legacy CAN and/or LIN devices (which make use of serial communication ports 214) and modern high speed devices (which make use of Ethernet ports 216), the local routing engine hardware 202 accelerates processing/translation from CAN/LIN frames to Ethernet frames, to help ensure that high data rates are achievable for system developers.

FIG. 3B illustrates another example of a control unit 200. In this example, rather than a single/shared routing table (e.g., 304 in FIG. 3A), the control unit 200 of FIG. 3B includes separate filter tables and separate routing tables for each channel. The CAN routing table(s) 310 include semiconductor memory that is coupled between the CAN acceptance filter 304-1 and CAN-to-Stream-ID logic 306-1, and stores CAN IDs with corresponding Stream IDs. Similarly, the LIN routing table(s) 310 include semiconductor memory that is coupled between the LIN acceptance filters 304 and LIN-to-Stream-ID logic 306-k, and stores LIN IDs with corresponding Stream IDs. In examples where the control unit 200 includes multiple CAN channels, a single CAN routing table can alternatively be shared among those multiple CAN channels. Similarly in examples where the control unit includes multiple LIN channels, a single LIN routing table can alternatively be shared among those multiple LIN channels.

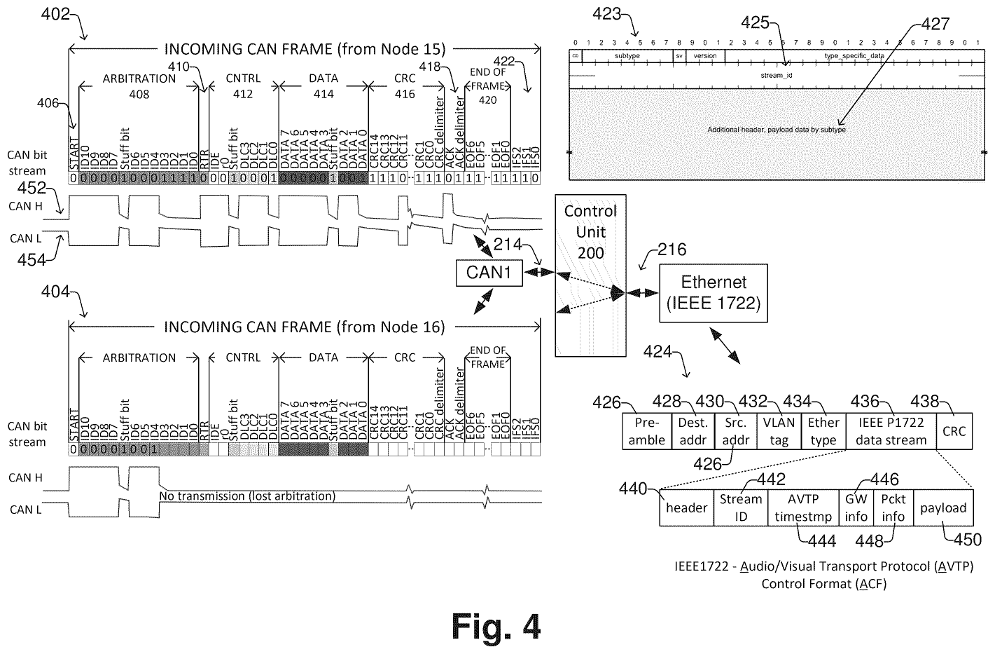

FIG. 4 illustrates a more detailed example that depicts two example incoming CAN frames 402, 404 received on a CAN port (CAN1) 214 of control unit 200. Each CAN frame includes a start bit 406, followed by several identification (ID) bits 408 (e.g., 11 ID bits or 29 ID bits), a remote request framed (RTR) bit 410, control (CNTRL) bits 412, data bits 414, cyclic redundancy check (CRC) bits 416, acknowledgement bits (ACK) 418, end of frame bits 420, and Inter Frame Space (IFS) bits 422. FIG. 4 also illustrates a more detailed example of an outgoing Ethernet frame 424 provided on an Ethernet port 216 of control unit 200. The Ethernet frame 424 includes a pre-amble 426, MAC destination address 428, MAC source address 430, Virtual Local Area network (VLAN) tag 432, Ethernet type field 434, IEEE P1722 data stream 436, and CRC data field 438. The IEEE P1722 data stream 436 includes a header 440, stream ID 442, Audio/Visual Transport Protocol (AVTP) timestamp 444, gateway (GW) info 446, packet info 448, and payload data 450. In some examples, the Ethernet frame conforms to IEEE1722 AVTP control format (ACF), which is a frame format/protocol for Ethernet that provides capability of sending CAN frames over a time-sensitive, Audio Video Bridging (AVB) network.

During network operation, the CAN frames 402, 404 are driven/generated by respective CAN devices (e.g., control units) that each send a respective CAN frame over a 2-wire serial bus that uses two differential wired-AND signals, CAN H 452 and CAN L 454. Each CAN device either drives CANH and CANL to a “dominant” state with CANH>CANL, or do not drive CANH and CANL such that passive resistors pull the 2-wire bus to a “recessive” state with CANH≤CANL. The dominant state represents a 0 data bit, while the recessive state represents a 1 data bit, which effectively gives CAN devices having lower ID numbers priority on the bus.

The exact voltages for a logical 0 or 1 depend on the physical layer used, but a basic principle of CAN is that each CAN device listens to the data on the CAN bus including the transmitting CAN device(s) itself (themselves). If a logical 1 is transmitted by all transmitting CAN devices at the same time, then a logical 1 is seen by all of the CAN devices, including both the transmitting CAN device(s) and receiving CAN device(s). If a logical 0 is transmitted by all transmitting CAN device(s) at the same time, then a logical 0 is seen by all CAN devices. If a logical 0 is being transmitted by one or more CAN devices, and a logical 1 is being transmitted by one or more CAN devices, then a logical 0 is seen by all CAN devices including the CAN device(s) transmitting the logical 1. When a CAN device transmits a logical 1 but sees a logical 0, it realizes that there is a contention and it quits transmitting. By using this process, any CAN device that transmits a logical 1, when another CAN device transmits a logical 0, loses the arbitration and drops out. A CAN device that loses arbitration re-queues its message for later transmission and the CAN frame bit-stream continues without error until only one CAN device is left transmitting.

For example, in the illustrated 11-bit ID CAN network in FIG. 4, the first CAN frame 402 is transmitted from a first CAN device with a CAN ID of 15 (binary representation, 00000001111) and the second frame CAN 404 is transmitted from a second CAN device with a CAN ID of 16 (binary representation, 00000010000). Assuming these two CAN devices start transmission of frames 402, 404 at the same time, each will first transmit the start bit 406 and then transmit the first six zeros of their ID (i.e., ID10-ID5) with no arbitration decision being made. When ID bit 4 is transmitted by both CAN devices, the second CAN frame 404 from the second CAN device transmits a 1 (recessive) for its ID, while the first CAN frame 402 from the first CAN device transmits a 0 (dominant) for its ID. When this happens, the second CAN device with the ID of 16 knows it transmitted a 1, but sees a 0 and realizes that there is a collision and it lost arbitration. Thus, the second CAN device stops transmitting, which allows the first CAN device with ID of 15 to continue its transmission of the remainder of frame 402 without any loss of data. Thus, the node with the lowest ID wins the arbitration and therefore has the highest priority. The second CAN device will re-queue the second CAN frame 404 and transmit at a later time when the CAN bus is available.

Thus, the control unit 200 includes circuitry to receive the CAN frames, and can map the CAN ID of a received, incoming CAN frame to a corresponding Stream ID stored in the routing table (e.g., 304 FIG. 3-4) of the control unit 200. Then, CAN-to-Stream-ID logic can build a Stream ID frame 423, which includes the Stream ID 425 identified in the routing table 310 as well as payload data 427 as in the incoming CAN frame (e.g., 427 is bitwise identical to 414). The Stream-ID-frame-to-Ethernet-frame-generation logic 208 can then build the outgoing Ethernet frame 424. The Ethernet frame 424 includes a Source address 430 in the Ethernet frame 424 specifying the control unit 200. The Ethernet frame 424 also includes the AVTP timestamp 444 which corresponds to a time stamp when the first CAN frame 402 was received at the control unit 200 according to the clock in the CPU (e.g., 204 FIGS. 3-4), and the payload 450 of Ethernet frame is bitwise identical to the data 414 in the incoming CAN frame 402. The Ethernet frame can also include the Stream ID corresponding to the incoming CAN frame. Thus, the CAN to Ethernet Frame generation channels (e.g., 208 of FIGS. 2, 3A, 3B) can capsulize the data of the incoming CAN frame to the payload field of the outgoing Ethernet frame. For example, in the example of FIG. 4, the CAN ID is Node 15, and the CAN routing table links Node 15 to a MAC source address of 00:00:1a:00:53:af (which identifies the control unit 200 and is here a 48-bit hexadecimal address, including six sets of two hexadecimal digits or characters, separated by colons). Although not shown, incoming Ethernet frames can also be “translated” to outgoing CAN frames. Thus, the control unit 200 also includes CAN arbitration logic to monitor the CAN bus, and determine when the Control Unit 200 (and its CAN ID) can transmit CAN messages with priority on the CAN bus relative to other CAN devices.

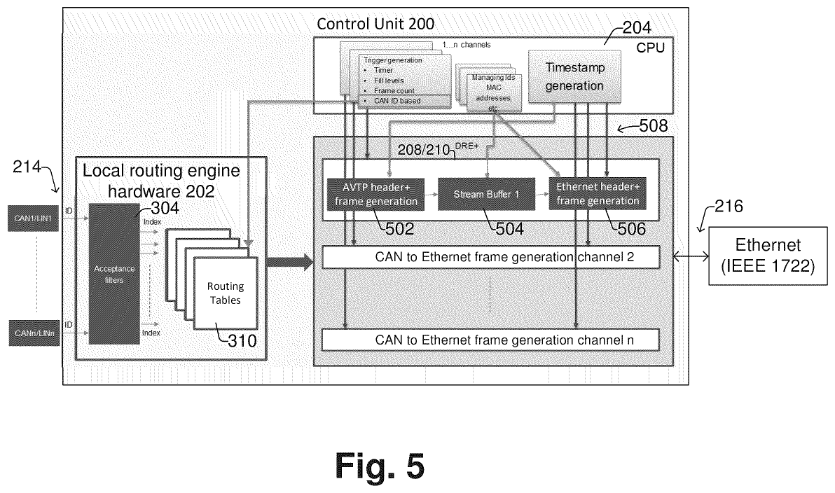

FIG. 5 shows more details of another way in which a Serial-port-frame-to-Stream-ID-frame generation logic can be implemented in accordance with some aspects of the present disclosure. These components include an AVTP header and frame generation logic block 502, a stream buffer 504, and an Ethernet header and frame generation logic block 506. The AVTP header and frame generation logic block 502 has an input coupled to an output of the local routing engine hardware 202, and the stream buffer 504 has an input coupled to an output of the AVTP header and frame generation logic block 502. The Ethernet header and frame generation logic block 506 has an input coupled to an output of the stream buffer 504. These components are also coupled to CPU 204 via one or more busses 508. The CPU 204 can generate a trigger signal when AVTP frames are completed by 502 and/or when Ethernet frames are completed by 506, and can manage device IDs such as MAC source addresses and MAC destination addresses. The CPU 204 also generates timestamps when CAN frames are received, and provides these timestamps to the AVTP header and frame generation logic 502 via bus 508 so the timestamps can be included in corresponding AVTP frames. The CPU 204 also sets timers, triggers filling and emptying of the stream buffer 504, and counts frames based on CAN IDs. Although details for only Stream-ID-frame-to-Ethernet-frame-generation logic channel 1 208/208 is illustrated, it will be appreciated that other channels generally have the same structure and functionality.

During operation of control unit 200 in FIG. 5, CAN frames are received at the serial ports 214. An acceptance filter 304 within the local routing engine hardware 202 determines whether each CAN frame is valid and intended for the control unit 200. This determination can be based on the CAN ID in the incoming CAN frame. If the incoming CAN frame has a CAN ID that is listed in the routing tables 310 of the local routing engine hardware 202, then the acceptance filter 302 determines the CAN frame is valid and accepts the CAN frame. Therefore, the incoming CAN frame is routed to a suitable routing channel (e.g., 208), where this routing can be based on the CAN ID and/or stream ID of the incoming CAN frame.

Upon receiving the incoming CAN frame, AVTP header and frame generation logic block 502 generates an AVTP frame, including (fields 440-450 in FIG. 4). Thus, the AVTP header and frame generation logic block 502 identifies data 414 and optionally stream ID in the incoming CAN frame, and uses those to generate payload data 450 and stream ID 442 in the AVTP header and frame. The CPU 204 can provide the AVTP timestamp 444 for the AVTP frame 436. This information for the AVTP frame 436 is then loaded into the stream buffer 504, along with this information for other AVTP frames in time. The stream buffer 504 can be a first-in-first-out (FIFO) memory, random access memory (RAM), or any other type of memory. The CPU 204 can monitor the AVTP header and frame generation logic block 502 and can trigger writes of the AVTP frames to the stream buffer 504 when frames are complete/assembled/built. The CPU can also trigger writes of AVTP frames from the stream buffer 504 to the Ethernet header and frame generation block 506. The Ethernet header and frame generation block 506 takes the AVTP frames, and appends Ethernet frame fields (e.g., fields 426-434 in FIG. 4) and a CRC 438 to generate Ethernet frames. These Ethernet frames are then transmitted via the Ethernet port 216.

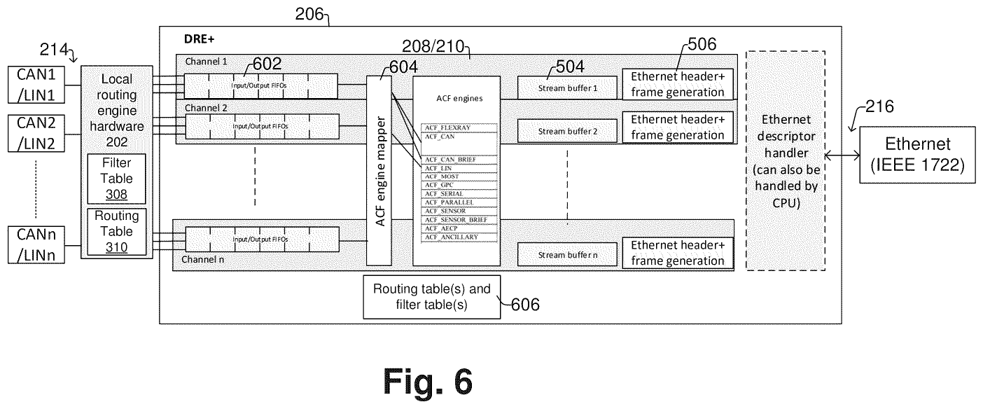

FIG. 6 shows another example of a Stream-ID-frame-to-Ethernet-frame-generation logic 208 in accordance with some aspects of the present disclosure. Although details for only one frame generation channel is described, it will be appreciated that other frame generation channels can have the same structure and functionality.

In FIG. 6, the Stream-ID-frame-to-Ethernet-frame-generation logic 208 includes input and/or output FIFOs or other memories 602. Typically, there is an input FIFO having an input coupled to serial port 214 via the local routing engine hardware 202, and a separate output FIFO having an output coupled to serial port 214. The output of the input FIFO in this example is coupled to ACF engine mapper hardware 604, which examines the header information of the AVTP header and generates portions of the Ethernet header and/or Ethernet frame based on the ACF information. Although the ACF engine mapper hardware 604 is illustrated as one logic block, the ACF engine mapper hardware is typically instantiated as separate ACF engine mappers in the respective channels. Thus, each channel typically has its own ACF engine mapper, such that the ACF engine mappers operate in parallel with the channels. For example, the ACF engine mapper hardware 604 can include logic to generate a number of different pre-determined frame formats for incoming FlexRay frames, CAN frames, LIN frames, sensor frames, parallel data frames, serial data frames, and others. Then, the ACF engine mapper hardware 604 can build Ethernet frames based on those different frame format types. Because hardware in the ACF engine mapper is configured to generate frame templates for the various frame types, the ACF engine mapper hardware represents an efficient way for a control unit to include multiple different serials ports, and easily and efficiently translate different frame formats received on those various ports to Ethernet frames.

Further, although much of the above description describes how incoming CAN/LIN/other frames are translated to outgoing Ethernet frames, the other way around is also possible (e.g., Ethernet to CAN/LIN/other). Therefore, to allow for this, the DRE+ includes routing and filtering tables 606 such that the DRE+ can map incoming Ethernet frames to outgoing CAN/LIN/other frames. Thus, in this other direction, the incoming Ethernet frame is broken down into CAN or LIN frames, which are filtered within the DRE+ and routed to the corresponding destination CAN or LIN nodes with the help of routing and filtering tables 606. Consequently, both the Local routing engine hardware 202 and DRE+ 206 have their own separate filter table and routing table. 14. Thus, DRE+ includes an Ethernet acceptance filter, an Ethernet routing table, and an Ethernet-frame-to-Stream-ID-frame circuit as well as a Stream-ID-frame-to-CAN-frame circuit. The Ethernet acceptance filter has an input coupled to the Ethernet interface. The Ethernet routing table has an input coupled to an output of the Ethernet acceptance filter and an output coupled to the CAN interface. The routing table stores a first plurality of Ethernet IDs and a second plurality of Stream IDs, respectively. These acceptance filters, routing tables, Ethernet-frame-to-Stream-ID-frame circuit and Stream-ID-frame-to-CAN-frame circuits can be implemented as separate channels arranged in parallel with one another.

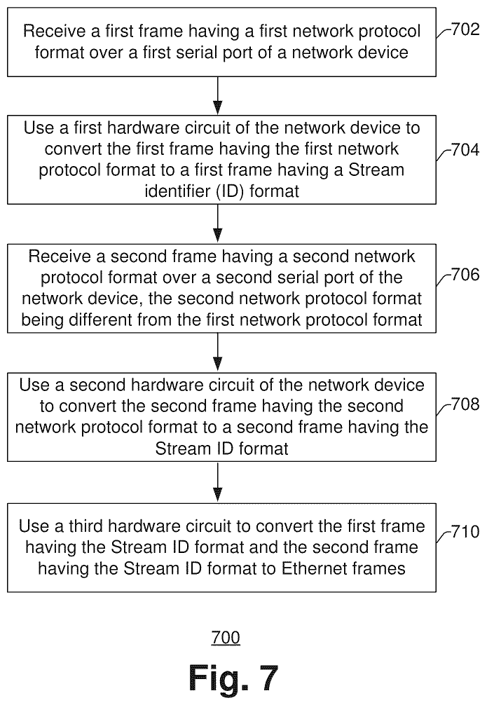

FIG. 7 illustrates a method 700 in accordance with some examples of the present disclosure. The ordering of the acts/steps of this method can be interchanged in other examples. In addition, in some cases, one or more illustrated acts/steps can be omitted, and/or can be subdivided into multiple acts/steps, and/or additional acts/steps that are not shown can also be included.

At 702, a first frame is received. The first frame has a first network protocol format, and is received over a first serial port of a network device. For example, the first frame can be a CAN frame received over a CAN port.

At 704, a first hardware circuit of the network device is used to convert the first frame to a first frame having a Stream identifier (ID) format. For example, in some examples, act/step 704 can be carried out by the CAN-to-Stream-ID circuits 306-1 to 306-j of FIG. 3A.

At 706, a second frame is received. The second frame has a second network protocol format, and is received over a second serial port of the network device. The second network protocol format is different from the first network protocol format. For example, the first frame can be a LIN frame received over a LIN port.

At 708, a second hardware circuit of the network device is used to convert the second frame to a second frame having the Stream ID format. For example, in some examples, act/step 708 can be carried out by the LIN-to-Stream-ID circuits 306-k of FIG. 3A. The second hardware circuit can be arranged in parallel with the first hardware circuit.

At 710, a third hardware circuit is used to convert the first frame having the Stream ID format and the second frame having the Stream ID format to Ethernet frames. For example, in some examples, act/step 710 can be carried out by the Stream-ID-frame-to-Ethernet-frame generation logic 208 of FIG. 3A. In some examples, the first network protocol format and the second network protocol format are selected from a group consisting of: Control Area Network (CAN), Local Interconnect Network (LIN), FlexRay, or I2C.

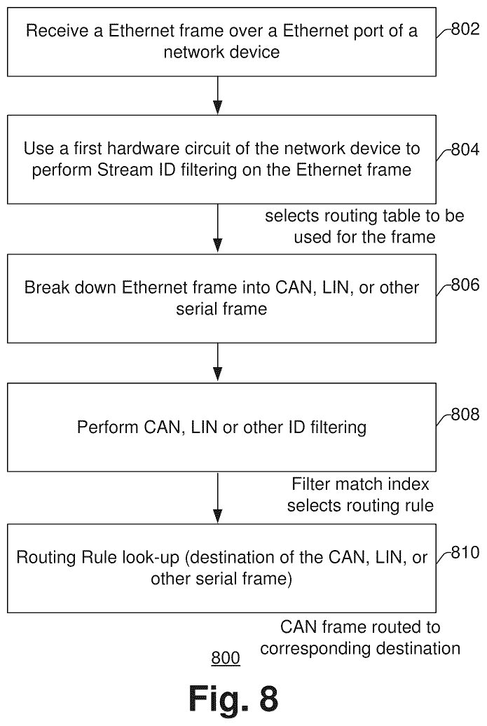

FIG. 8 illustrates another method 800 in accordance with some examples of the present disclosure. The ordering of the acts/steps of this method can be interchanged in other examples. In addition, in some cases, one or more illustrated acts/steps can be omitted, and/or can be subdivided into multiple acts/steps, and/or additional acts/steps that are not shown can also be included.

At 802, an Ethernet frame is received over an Ethernet port of a network device.

At 804, a first hardware circuit of the network device is used to perform Stream ID filtering on the Ethernet frame. Thus, the Steam ID of the Ethernet frame is identified in the Ethernet packet, and the Stream ID selects a routing table to be used for the frame.

At 806, the method breaks down the Ethernet frame and builds the data fields of the Ethernet frame into a CAN, LIN, or other serial frame.

At 808, the method performs CAN, LIN, or other serial filtering based on the Stream ID of the Ethernet frame and/or corresponding CAN, LIN, or other serial frame.

At 810, the method uses a Routing rule look-up to set the destination of the CAN, LIN, or other serial frame to the appropriate serial port of the device based on the Stream ID. Thus, the CAN, LIN, or other serial frame is routed to the appropriate destination device using the appropriate serial port.

While the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below. The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A control unit, comprising:
a Controller Area Network (CAN) interface including a plurality of serial communication ports;
a first plurality of CAN-to-Stream-identifier (ID) logic circuits coupled to the plurality of serial communication ports, respectively;
a routing table coupled to the first plurality of CAN-to-Stream-ID logic circuits, the routing table configured to store a first plurality of CAN IDs and a first plurality of Stream IDs, respectively;
an Ethernet interface; and
a Stream-ID-frame-to-Ethernet-frame-generation logic having a plurality of inputs coupled to respective outputs of the first plurality of CAN-to-Stream-ID logic circuits, respectively, and having respective outputs coupled to the Ethernet interface, the first plurality of CAN-to-Stream-ID logic circuits instantiated in a first plurality of hardware circuits, respectively.

2. The control unit of claim 1, further comprising:
a Local Interconnect Network (LIN) interface, wherein the routing table stores a second plurality of LIN IDs and a second plurality of Stream IDs, respectively; and
a second plurality of LIN-to-Stream-ID logic circuits that have outputs coupled to the Stream-ID-frame-to-Ethernet-frame-generation logic.

3. The control unit of claim 2, further comprising:
a CAN acceptance filter arranged between the CAN interface and the first plurality of CAN-to-Stream-ID logic circuits; and
a LIN acceptance filter arranged between the LIN interface and the second plurality of LIN-to-Stream-ID logic circuits.

4. The control unit of claim 3, further comprising:
a filter table coupled to the CAN acceptance filter and configured to store a CAN ID, wherein the CAN acceptance filter is configured to receive incoming CAN frames and route an incoming CAN frame to a CAN-to-Stream-ID logic circuit only when a CAN ID in the incoming CAN frame corresponds to the CAN ID in the filter table.

5. The control unit of claim 4, wherein the routing table is configured to store a first Stream ID that maps to the CAN ID, and is configured to store a second CAN ID and a second Stream ID that maps to the second CAN ID.

6. The control unit of claim 5, wherein the filter table is coupled to the LIN acceptance filter and configured to store a LIN ID, wherein the LIN acceptance filter is configured to receive incoming LIN frames and route an incoming LIN frame to a LIN-to-Stream-ID logic circuit only when a LIN ID in the incoming LIN frame corresponds to the LIN ID in the filter table.

7. The control unit of claim 6, wherein the first plurality of CAN-to-Stream-ID logic circuits are configured to generate a first plurality of Stream ID frames based on the incoming CAN frames, and the second plurality of LIN-to-Stream-ID logic circuits are configured to generate a second plurality of Stream ID frames based on the incoming LIN frames, and the first plurality of Stream ID frames and the second plurality of Stream ID frames are both provided to the Stream-ID-frame-to-Ethernet-frame-generation logic.

8. The control unit of claim 7, wherein the Stream-ID-frame-to-Ethernet-frame-generation logic is configured to encapsulate the first plurality of Stream ID frames and the second plurality of Stream ID frames into a plurality of Ethernet frames.

9. The control unit of claim 8, wherein the Stream-ID-frame-to-Ethernet-frame-generation logic is configured to transmit the plurality of Ethernet frames over a single Ethernet port of the Ethernet interface.

10. The control unit of claim 5, further comprising:
a central processing unit (CPU) coupled to the control unit via a bus, the CPU configured to generate a timestamp based on when the incoming CAN frame is received by the control unit.

11. The control unit of claim 10, wherein the CAN-to-Stream-ID logic circuit comprises:
an audiovisual control format (ACF) header and frame generation logic; and
a stream buffer having an input and an output, the input of the stream buffer coupled to an output of the ACF header and frame generation logic.

12. The control unit of claim 11, wherein the CPU is coupled to the stream buffer via a bus, and triggers filling and emptying of the stream buffer.

13. The control unit of claim 1, wherein the first plurality of hardware circuits are arranged on a single semiconductor substrate and the first plurality of hardware circuits are substantially identical to one another.

14. The control unit of claim 1, further comprising:
an Ethernet acceptance filter coupled to the Ethernet interface;
an Ethernet routing table having an input coupled to the Ethernet acceptance filter and an output coupled to the CAN interface, the routing table configured to store a first plurality of Ethernet IDs and a second plurality of Stream IDs, respectively;
an Ethernet-frame-to-Stream-ID-frame circuit having an input coupled to the Ethernet acceptance filter; and
a Stream-ID-frame-to-CAN-frame circuit having an input coupled to the Ethernet-frame-to-Stream-ID-frame circuit and an output coupled to the CAN interface.

15. A vehicle, comprising:
a first sensor or controller, the first sensor or controller having a controller area network (CAN) interface;
a pair of copper wires having a first end and a second end, the first end of the pair of copper wires coupled to the CAN interface of the first sensor or controller;
a second sensor or controller, the second sensor or controller having an Ethernet interface;
an Ethernet cable having a first end and a second end, the first end of the Ethernet cable coupled to the Ethernet interface of the second sensor or controller; and
a control unit confined in a housing and including a CAN port and an Ethernet port in the housing, the CAN port of the control unit coupled to the second end of the copper wire, and the Ethernet port of the control unit coupled to the second end of the Ethernet cable;
wherein the control unit comprises:
a CAN acceptance filter coupled to the CAN port;
a CAN-to-Stream-ID logic circuit having an input coupled to an output of the CAN acceptance filter; and
a Stream-ID-frame-to-Ethernet-frame-generation logic having a first input coupled to an output of the CAN-to-Stream-ID logic circuit and having an output coupled to the Ethernet interface.

16. The vehicle of claim 15, wherein the control unit further comprises:
a Local Interconnect Network (LIN) port;
a LIN acceptance filter coupled to the LIN port; and
a LIN-to-Stream-ID logic circuit having an input coupled to an output of the LIN acceptance filter and having an output coupled to the Stream-ID-frame-to-Ethernet-frame-generation logic.

17. The vehicle of claim 15, wherein the control unit further comprises:
a filter table coupled to the CAN acceptance filter and configured to store a CAN ID, wherein the CAN acceptance filter is configured to receive incoming CAN frames on the CAN port and route an incoming CAN frame to the CAN-to-Stream-ID logic circuit only when a CAN ID in the incoming CAN frame corresponds to the CAN ID in the filter table.

18. The vehicle of claim 15, wherein the control unit further comprises:
a routing table coupled to the CAN-to-Stream-ID logic circuit and configured to store a plurality of CAN IDs with a plurality of Stream IDs, respectively, wherein the CAN-to-Stream-ID logic circuit is configured to generate a Stream ID frame that include a Stream ID of an incoming CAN frame along with payload data of the incoming CAN frame.

19. A method, comprising
receiving a first frame having a first network protocol format over a first serial port of a network device;
using a first hardware circuit of the network device to convert the first frame having the first network protocol format to a first frame having a Stream identifier (ID) format;
receiving a second frame having a second network protocol format over a second serial port of the network device, the second network protocol format being different from the first network protocol format;
using a second hardware circuit of the network device to convert the second frame having the second network protocol format to a second frame having the Stream ID format; and
using a third hardware circuit to convert the first frame having the Stream ID format and the second frame having the Stream ID format to Ethernet frames.

20. The method of claim 19, wherein the second hardware circuit is arranged in parallel with the first hardware circuit.

21. The method of claim 19, wherein the first network protocol format and the second network protocol format are selected from a group consisting of: Control Area Network (CAN), Local Interconnect Network (LIN), FlexRay, or I2C.
